(19) United States
(12) Patent Application Publication
(10) Pub. No.: US 2012/0075346 A1
(43) Pub. Date: Mar. 29, 2012

(54) Low Complexity Method For Motion Compensation Of DWT Based Systems

(75) Inventors: Krishna Mohan Malladi, San Jose, CA (US); B. Anil Kumar, Saratoga, CA (US)

(73) Assignee: Microsoft Corporation, Redmond, WA (US)

(21) Appl. No.: 12/893,969

(22) Filed: Sep. 29, 2010

(51) Int. Cl. G09G 5/00; G06T 15/00

(52) U.S. Cl. 345/660; 345/419

(57) ABSTRACT

Exemplary techniques for performing motion compensation in the discrete wavelet transform domain are described. In an exemplary embodiment, a server can perform motion compensation in the discrete wavelet transform domain for an image and send at least one motion vector and at least one delta array to a client. The client can use the at least one motion vector and the at least one delta array to compose the image. In addition to the foregoing, other aspects are described in the detailed description, claims, and figures.

### BACKGROUND

Virtual machine platforms enable the simultaneous execution of multiple guest operating systems on a physical machine by running each operating system within its own virtual machine. One exemplary service that can be offered in a virtual machine is a virtual desktop session. A virtual desktop session is essentially a personal computer environment run within a virtual machine that has its user interface sent to a remote computer. This architecture is similar to a remote desktop environment, however instead of having multiple users simultaneously connect to an operating system, in a virtual desktop session each user has access to their own operating system executing in a virtual machine in a virtual desktop environment.

Modern operating systems render three-dimensional (3D) graphical user interfaces for 3D applications/videogames and its operating system user interface. Users enjoy the experience of interacting with a 3D environment and it would be desirable to be able to stream 3D graphics to a client in a virtual desktop session; however, enabling streaming 3D graphics is difficult for numerous reasons. For example, the act of streaming 3D graphics requires bandwidth and/or compression. Bandwidth is limited and is typically not under the control of either the client or the server when connecting over the Internet. Compression can reduce the amount of data that has to be sent from the server to the client; however compression operations have high latency and are processor intensive. Accordingly, schemes for reducing the amount of data that has to be sent to the client and/or the time it takes to compress said data are desirable.

### SUMMARY

An exemplary embodiment includes a system. In this example, the system includes, but is not limited to a processor and a memory in communication with the processor when the computer system is operational. In this example, the memory can include computer readable instructions that upon execution cause the processor to decompose, via a discrete wavelet transform procedure, an image tile to into a group of sub-band images, wherein the group of sub-band images includes at least a low pass sub-band image; quantize the group of sub-band images; determine a group of motion vectors from the low pass sub-band image and a previous version of the low pass sub-band image; determine a group of delta arrays for the group of sub-band image from previous versions of the group of sub-band images and the group of motion vectors; and send the determined delta arrays and the group of motion vectors to a remote computer system. In addition to the foregoing, other techniques are described in the claims, the detailed description, and the figures.

Another exemplary embodiment includes a method. In this example, the method includes, but is not limited to decomposing, via a discrete wavelet transform procedure, an image tile to into a group of first-level sub-band images, a group of second-level sub-band images, and a group of third-level sub-band images; quantizing the group of first-level sub-band images, the group of second-level sub-band images, and the group of third-level sub-band images; determining a group of third-level motion vectors from a third-level low pass sub-band image and a previous version of the third-level low pass sub-band image; determining delta arrays for the group of first-level sub-band images, the group of second-level sub-band images, and the group of third-level sub-band images from reference sub-band images and the group of third-level motion vectors; and sending the determined delta arrays and at least the group of third-level motion vectors to a remote computer system. In addition to the foregoing, other techniques are described in the claims, the detailed description, and the figures.

Another exemplary embodiment includes a computer-readable storage medium. In this example, the computer-readable storage medium includes computer readable instructions that upon execution cause a processor to reposition a group of sub-band images according to a group of motion vectors; apply delta arrays to the group of repositioned sub-band images thereby obtaining a group of motion compensated sub-band images; inverse quantize the group of motion compensated sub-band images; compose, via an inverse discrete wavelet transform procedure, the group of motion compensated sub-band images into an image tile; and display the image tile. In addition to the foregoing, other techniques are described in the claims, the detailed description, and the figures.

It can be appreciated by one of skill in the art that one or more various aspects of the disclosure may include but are not limited to circuitry and/or programming for effecting the herein-referenced aspects; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts a high-level block diagram of a computer system.

FIG. 2 depicts a high-level block diagram of a virtual machine server.

FIG. 3 depicts a high-level block diagram of a virtual machine server.

FIG. 4 depicts a high-level block diagram of a virtual desktop server.

FIG. 5 depicts a high-level block diagram of a virtual desktop server.

FIG. 6 depicts an exemplary compression algorithm.

FIG. 7 illustrates a decomposed image tile.

FIG. 8 depicts an operational procedure for compressing an image.

FIG. 9 illustrates the operational procedure of FIG. 8 including additional operations.

FIG. 10 depicts an operational procedure for compressing an image.

FIG. 11 illustrates the operational procedure of FIG. 10 including additional operations.

FIG. 12 depicts an operational procedure for compressing an image.

FIG. 13 illustrates the operational procedure of FIG. 12 including additional operations.

### DETAILED DESCRIPTION

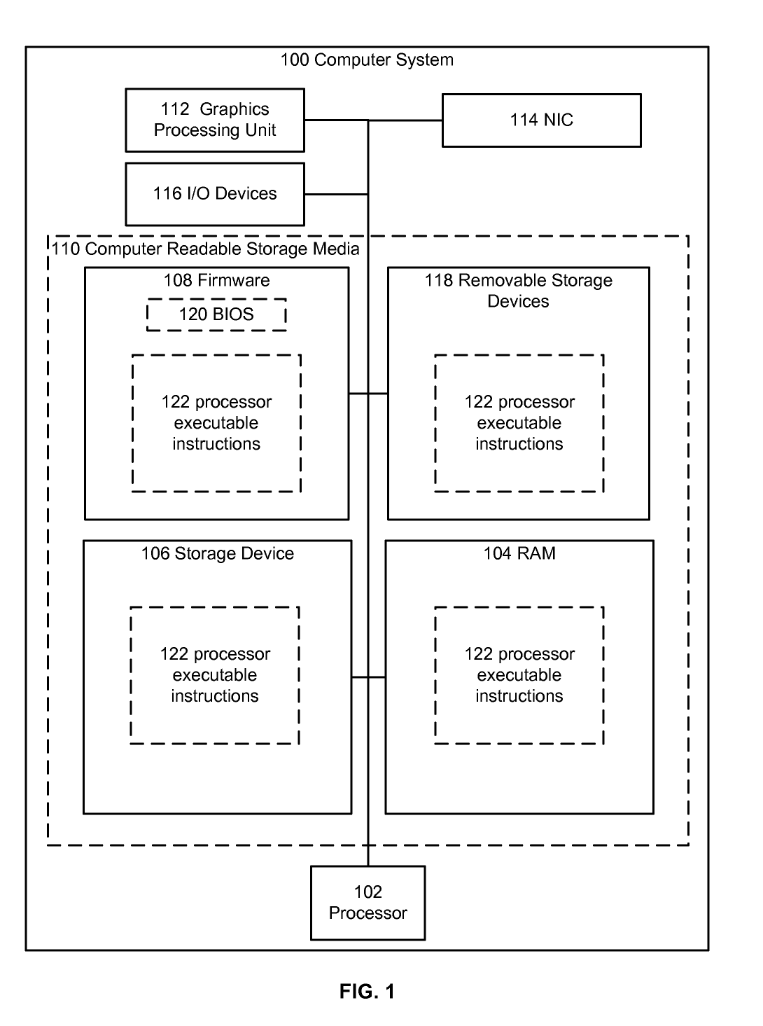

The disclosed subject matter may use one or more computer systems. FIG. 1 and the following discussion are intended to provide a brief general description of a suitable computing environment in which the disclosed subject matter may be implemented.

The term circuitry used throughout can include hardware components such as hardware interrupt controllers, hard drives, network adaptors, graphics processors, hardware based video/audio codecs, and the firmware used to operate such hardware. The term circuitry can also include microprocessors, application specific integrated circuits, and processors, e.g., cores of a multi-core general processing unit that perform the reading and executing of instructions, configured by firmware and/or software. Processor(s) can be configured by instructions loaded from memory, e.g., RAM, ROM, firmware, and/or mass storage, embodying logic operable to configure the processor to perform a function(s). In an example embodiment, where circuitry includes a combination of hardware and software, an implementer may write source code embodying logic that is subsequently compiled into machine readable code that can be executed by hardware. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary computing system 100 is depicted. Computer system 100 can include processor 102, e.g., an execution core. While one processor 102 is illustrated, in other embodiments computer system 100 may have multiple processors, e.g., multiple execution cores per processor substrate and/or multiple processor substrates that could each have multiple execution cores. As shown by the figure, various computer-readable storage media 110 can be interconnected by one or more system busses which couples various system components to the processor 102. The system buses may be any of several types of bus structures including a memory bus or memory controller, a peripheral bus, and a local bus using any of a variety of bus architectures. In example embodiments the computer-readable storage media 110 can include for example, random access memory (RAM) 104, storage device 106, e.g., electromechanical hard drive, solid state hard drive, etc., firmware 108, e.g., FLASH RAM or ROM, and removable storage devices 118 such as, for example, CD-ROMs, floppy disks, DVDs, FLASH drives, external storage devices, etc. It should be appreciated by those skilled in the art that other types of computer readable storage media can be used such as magnetic cassettes, flash memory cards, and/or digital video disks.

The computer-readable storage media 110 can provide non volatile and volatile storage of processor executable instructions 122, data structures, program modules and other data for the computer 100 such as executable instructions. A basic input/output system (BIOS) 120, containing the basic routines that help to transfer information between elements within the computer system 100, such as during start up, can be stored in firmware 108. A number of programs may be stored on firmware 108, storage device 106, RAM 104, and/or removable storage devices 118, and executed by processor 102 including an operating system and/or application programs.

Commands and information may be received by computer 100 through input devices 116 which can include, but are not limited to, a keyboard and pointing device. Other input devices may include a microphone, joystick, game pad, scanner or the like. These and other input devices are often connected to processor 102 through a serial port interface that is coupled to the system bus, but may be connected by other interfaces, such as a parallel port, game port, or universal serial bus (USB). A display or other type of display device can also be connected to the system bus via an interface, such as a video adapter which can be part of, or connected to, a graphics processor unit 112. In addition to the display, computers typically include other peripheral output devices, such as speakers and printers (not shown). The exemplary system of FIG. 1 can also include a host adapter, Small Computer System Interface (SCSI) bus, and an external storage device connected to the SCSI bus.

Computer system 100 may operate in a networked environment using logical connections to one or more remote computers, such as a remote computer. The remote computer may be another computer, a server, a router, a network PC, a peer device or other common network node, and typically can include many or all of the elements described above relative to computer system 100.

When used in a LAN or WAN networking environment, computer system 100 can be connected to the LAN or WAN through network interface card 114. The NIC 114, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

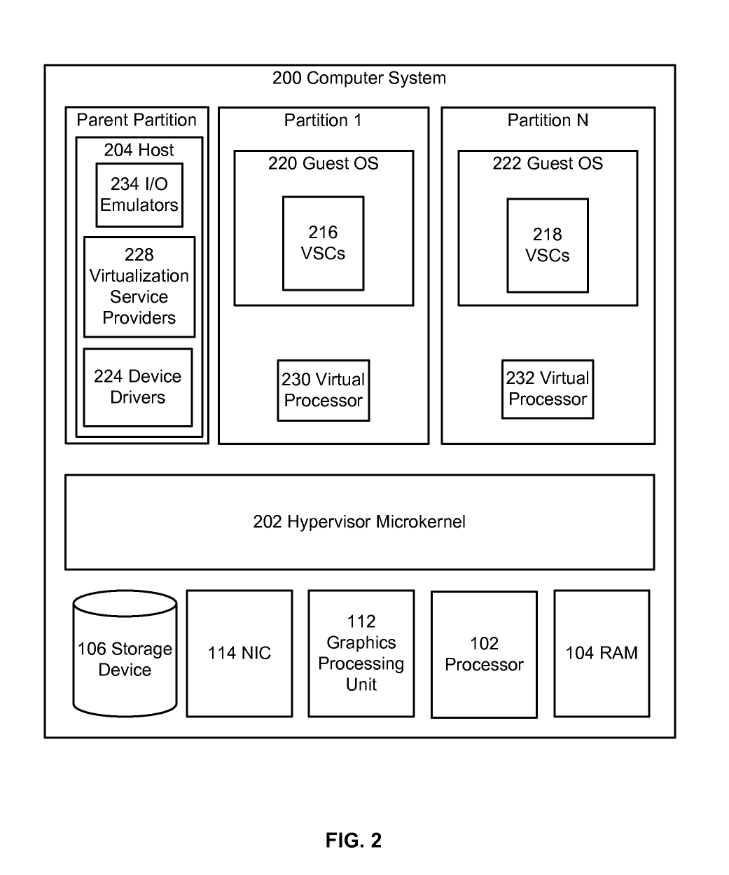

Turning to FIG. 2, illustrated is an exemplary virtualization platform that can be used to generate virtual machines. In this embodiment, hypervisor microkernel 202 can be configured to control and arbitrate access to the hardware of computer system 200. Hypervisor microkernel 202 can generate execution environments called partitions such as child partition 1 through child partition N (where N is an integer greater than 1). Here, a child partition is the basic unit of isolation supported by hypervisor microkernel 202. Hypervisor microkernel 202 can isolate processes in one partition from accessing another partition's resources. Each child partition can be mapped to a set of hardware resources, e.g., memory, devices, processor cycles, etc., that is under control of the hypervisor microkernel 202. In embodiments hypervisor microkernel 202 can be a stand-alone software product, a part of an operating system, embedded within firmware of the motherboard, specialized integrated circuits, or a combination thereof.

Hypervisor microkernel 202 can enforce partitioning by restricting a guest operating system's view of the memory in a physical computer system. When hypervisor microkernel 202 instantiates a virtual machine, it can allocate pages, e.g., fixed length blocks of memory with starting and ending addresses, of system physical memory (SPM) to the virtual machine as guest physical memory (GPM). Here, the guest's restricted view of system memory is controlled by hypervisor microkernel 202. The term guest physical memory is a shorthand way of describing a page of memory from the viewpoint of a virtual machine and the term system physical memory is shorthand way of describing a page of memory from the viewpoint of the physical system. Thus, a page of memory allocated to a virtual machine will have a guest physical address (the address used by the virtual machine) and a system physical address (the actual address of the page).

A guest operating system may virtualize guest physical memory. Virtual memory is a management technique that allows an operating system to over commit memory and to give an application sole access to a contiguous working memory. In a virtualized environment, a guest operating system can use one or more page tables to translate virtual addresses, known as virtual guest addresses into guest physical addresses. In this example, a memory address may have a guest virtual address, a guest physical address, and a system physical address.

In the depicted example, parent partition component, which can also be also thought of as similar to domain 0 of Xen's open source hypervisor can include a host 204. Host 204 can be an operating system (or a set of configuration utilities) and host 204 can be configured to provide resources to guest operating systems executing in the child partitions 1-N by using virtualization service providers 228 (VSPs). VPSs 228, which are typically referred to as back-end drivers in the open source community, can be used to multiplex the interfaces to the hardware resources by way of virtualization service clients (VSCs) (typically referred to as front-end drivers in the open source community or paravirtualized devices). As shown by the figures, virtualization service clients execute within the context of guest operating systems. However, these drivers are different than the rest of the drivers in the guest in that they may be supplied with a hypervisor, not with a guest. In an exemplary embodiment the path used to by virtualization service providers 228 to communicate with virtualization service clients 216 and 218 can be thought of as the virtualization path.

As shown by the figure, emulators 234, e.g., virtualized IDE devices, virtualized video adaptors, virtualized NICs, etc., can be configured to run within host 204 and are attached to resources available to guest operating systems 220 and 222. For example, when a guest OS touches a memory location mapped to where a register of a device would be or memory mapped device, microkernel hypervisor 202 can intercept the request and pass the values the guest attempted to write to an associated emulator. Here, the resources in this example can be thought of as where a virtual device is located. The use of emulators in this way can be considered the emulation path. The emulation path is inefficient compared to the virtualized path because it requires more CPU resources to emulate device than it does to pass messages between VSPs and VSCs. For example, the hundreds of actions on memory mapped to registers required in order to write a value to disk via the emulation path may be reduced to a single message passed from a VSC to a VSP in the virtualization path.

Each child partition can include one or more virtual processors (230 and 232) that guest operating systems (220 and 222) can manage and schedule threads to execute thereon. Generally, the virtual processors are executable instructions and associated state information that provide a representation of a physical processor with a specific architecture. For example, one virtual machine may have a virtual processor having characteristics of an Intel x86 processor, whereas another virtual processor may have the characteristics of a PowerPC processor. The virtual processors in this example can be mapped to processors of the computer system such that the instructions that effectuate the virtual processors will be backed by processors. Thus, in an embodiment including multiple processors, virtual processors can be simultaneously executed by processors while, for example, other processor execute hypervisor instructions. The combination of virtual processors and memory in a partition can be considered a virtual machine.

Guest operating systems (220 and 222) can be any operating system such as, for example, operating systems from Microsoft®, Apple®, the open source community, etc. The guest operating systems can include user/kernel modes of operation and can have kernels that can include schedulers, memory managers, etc. Generally speaking, kernel mode can include an execution mode in a processor that grants access to at least privileged processor instructions. Each guest operating system can have associated file systems that can have applications stored thereon such as terminal servers, e-commerce servers, email servers, etc., and the guest operating systems themselves. The guest operating systems can schedule threads to execute on the virtual processors and instances of such applications can be effectuated.

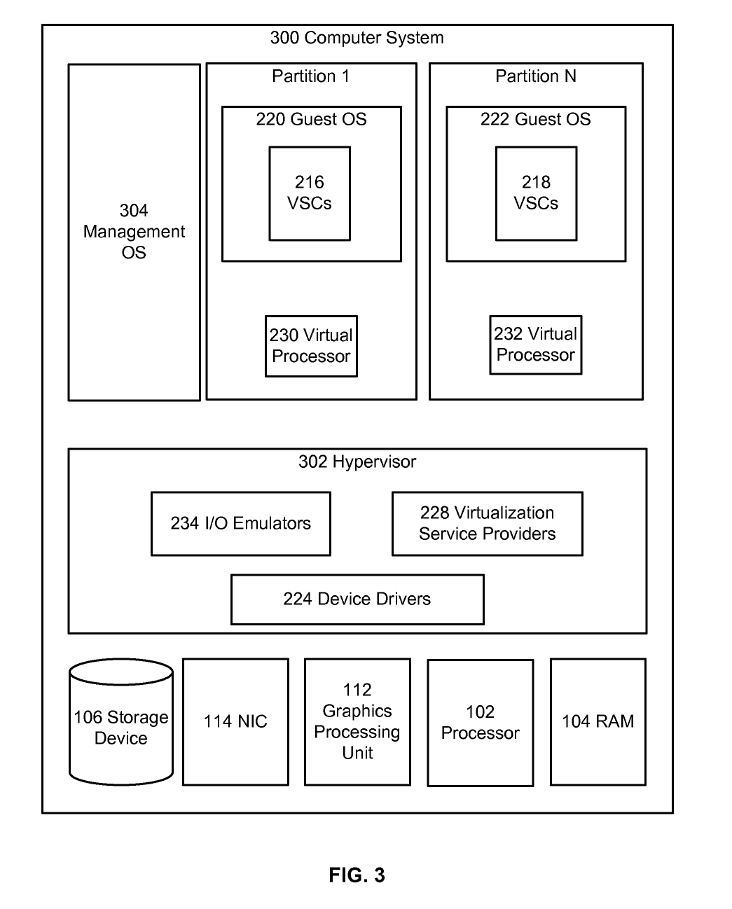

Referring now to FIG. 3, it illustrates an alternative virtualization platform to that described above in FIG. 2. FIG. 3 depicts similar components to those of FIG. 2; however, in this example embodiment hypervisor 302 can include a microkernel component and components similar to those in host 204 of FIG. 2 such as the virtualization service providers 228 and device drivers 224, while management operating system 304 may contain, for example, configuration utilities used to configure hypervisor 302. In this architecture, hypervisor 302 can perform the same or similar functions as hypervisor microkernel 202 of FIG. 2; however, in this architecture hypervisor 302 of FIG. 3 can be configured to provide resources to guest operating systems executing in the child partitions. Hypervisor 302 of FIG. 3 can be a stand alone software product, a part of an operating system, embedded within firmware of the motherboard or a portion of hypervisor 302 can be effectuated by specialized integrated circuits.

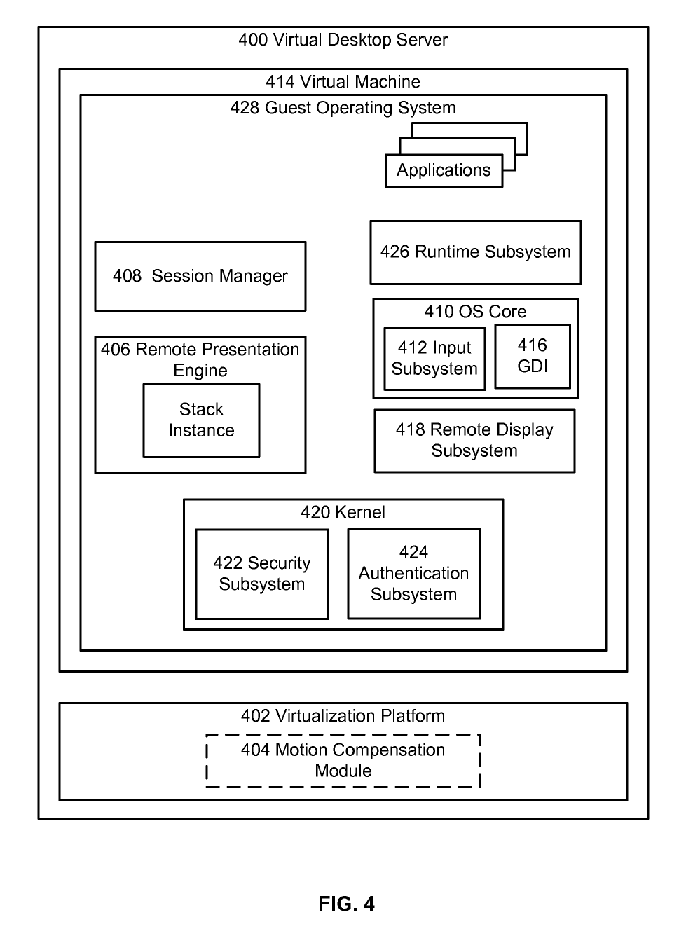

Turning now to FIG. 4, it illustrates a high-level block diagram of virtual desktop server 400. In an embodiment, virtual desktop server 400 can be configured to deploy virtual desktop sessions (VDS) to clients, e.g., mobile devices such as smart phones, computer systems having components similar to those illustrated in FIG. 1, etc. Briefly, virtual desktop technology allows a user to remotely interact with a guest operating system running in a virtual machine. Unlike a remote desktop session, in a virtual desktop session only one user is logged into a guest operating system and the user can have total control of it, e.g., the user runs as an administrator and has full rights on the guest. In the illustrated example, virtual desktop server 400 can have components similar to computer system 200 or 300 of FIG. 2 or FIG. 3. Virtualization platform 402 is a logical abstraction of virtualization infrastructure components described above in FIG. 2 and FIG. 3. The functionality described in the following sections as “within” virtualization platform 402 can be implemented in one or more of the elements depicted in FIG. 2 or FIG. 3. For example, 3D graphics service manager 404, which is described in more detail in the following paragraphs, can be implemented in a host 204 of FIG. 2. In a more specific example, 3D graphics service manager 404 can be implemented in a host operating system running in a parent partition.

Starting a virtual desktop session requires the instantiation of a guest operating system within a virtual machine. In an exemplary embodiment, a virtual desktop manager, e.g., a module of processor executable instructions, can start up virtual machine 414 (which can boot guest operating system 428) in response to a request. The virtual desktop manager can execute on a processor and instruct virtualization platform 402, e.g., microkernel hypervisor 202, to allocate memory for a partition. Virtualization platform 402 can execute and configure virtual devices within memory of virtual machine 414 and load a boot loader program into memory allocated to VM 414. The boot loader program can execute on a virtual processor (which in turn can run on a processor) and guest operating system 428 can be loaded within virtual machine 414. Session manager 408 can be loaded by guest operating system 428 and it can load environment subsystems such as runtime subsystem 426 that can include a kernel mode part such as operating system core 410. The environment subsystems in an embodiment can be configured (c) to expose a subset of services to application programs and provide an access point to kernel 420. When guest operating system 428 is loaded, the boot loader program can exit and turn control of virtual machine 414 over to guest operating system 428. Guest operating system 428 can execute the various modules illustrated in FIG. 4 and configure itself to host a virtual desktop session. For example, guest operating system 428 can include registry values that cause remote presentation engine 406, session manager 408, etc. to start upon boot.

At some point after guest operating system 428 is running it can receive a connection request from a client. The incoming connection request can first be handled by remote presentation engine 406, which can be configured to listen for connection messages, and when one is received it can spawn a stack instance. Remote presentation engine 406 can run a protocol stack instance for the session and 3D graphical user interface (rendered in virtualization platform 402) can be captured by remote display subsystem 418 and sent via the protocol stack instance to a client. Generally, the protocol stack instance can be configured to route user interface output to an associated client and route user input received from the associated client to operating system core 410. Briefly, operating system core 410 can be configured to manage screen output; collect input from keyboards, mice, and other devices.

A user credential, e.g., a username/password combination, can be received by remote presentation engine 406 and passed to session manager 408. Session manager 408 can pass the credential to a logon procedure, which can route the credential to authentication subsystem 424 for verification. Authentication subsystem 424 can determine that the user credential is valid and a virtual desktop session can be started, i.e., the user can be logged into guest operating system 428.

Authentication subsystem 424 can also generate a system token, which can be used whenever a user attempts to execute a process to determine whether the user has the security credentials to run the process or thread. For example, when a process or thread attempts to gain access, e.g., open, close, delete, and/or modify an object, e.g., a file, setting, or an application, the thread or process can be authenticated by security subsystem 422. Security subsystem 422 can check the system token against an access control list associated with the object and determine whether the thread has permission based on a comparison of information in the system token and the access control list. If security subsystem 422 determines that the thread is authorized then the thread can be allowed to access the object.

Continuing with the description of FIG. 4, in an embodiment the operating system core 410 can include a graphics display interface 416 (GDI) and input subsystem 412. Input subsystem 412 in an example embodiment can be configured to receive user input from a client via the protocol stack instance for the virtual desktop session and send the input to operating system core 410. The user input can in some embodiments include signals indicative of absolute and/or relative mouse movement commands, mouse coordinates, mouse clicks, keyboard signals, joystick movement signals, etc. User input, for example, a mouse double-click on an icon, can be received by the operating system core 410 and the input subsystem 412 can be configured to determine that an icon is located at the coordinates associated with the double-click. Input subsystem 412 can then be configured to send a notification to runtime subsystem 426 that can execute a process for the application associated with the icon.

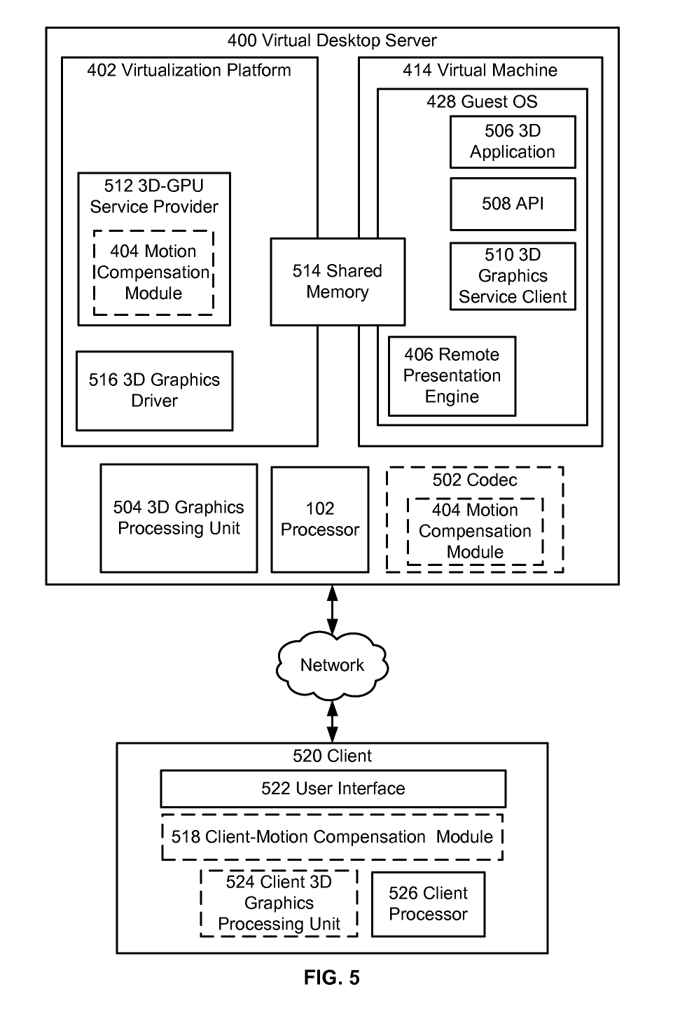

Turning to FIG. 5, it illustrates components for configuring virtual desktop server 400 to stream images indicative of three-dimensional graphical user interfaces to a client such as client 520. Briefly, client 520 can include a computer system having components similar to those illustrated in FIG. 1, a mobile device, or a thin-client. For example, the thin-client may have commodity hardware and a monolithic web-browser configured to manage the hardware, user input and output, and connect to the Internet. In this example, the thin-client may also include client-motion compensation module 518, which will be described in more detail in the following paragraphs, client processor 526, user interface 522, e.g., a display, and optionally client 3D graphics processing unit 524.

Virtual desktop server 400 can include motion compensation module 404, which is illustrated in dashed lines to indicate that in an exemplary embodiment motion compensation module 404 can be effectuated by a processing unit, e.g., processor 102 or graphics processing unit 504, or implemented within firmware or logic of codec 502. For example, motion compensation module 404 can be written in instructions that cause single instruction, multiple data (SIMD) instructions within x86 based processors to handle certain operations. In another example, motion compensation module 404 can be written in a shader language. In yet another example, logical for motion compensation module 404 can be implemented in hardware within codec 502 that can be attached to the motherboard of virtual desktop server 400. In an exemplary embodiment, an instance of motion compensation module can be running on 3D graphics processing unit 504, another instance can be running on processor 102, and codec 502 can be performing motion compression module operations. The selection of effectuating motion compensation module 404 by a CPU, a GPU, and/or within hardware is a design choice that can be based on the amount of processors and graphical processing units within virtual desktop server 400 and the desirability of implementing the module in hardware or a combination of hardware/software. Such a choice is left to an implementer.

Continuing with the description of FIG. 5, it illustrates 3D application 506, which can be a graphical user interface of guest operating system 428, a 3D word processing program, a 3D videogame, etc. 3D application can issue instructions to 3D graphics application program interface 508 (API), which can be an API such as Direct3D from Microsoft®. Briefly, 3D graphics API 508 provides an abstraction layer between a graphics application, e.g., a videogame, and 3D graphics service client 510. On one end, 3D graphics API 508 provides a low-level interface to graphics processing unit interfaces exposed by 3D graphics service client 510 and on the other it provides a library of 3D graphics commands that can be called by applications. API 508 can map the library of 3D graphics commands to the interfaces exposed by 3D graphics service client 510 thus freeing game developers from having to understand the particularities of every graphics driver.

In operation, API 508 can generate primitives, e.g., the fundamental geometric shapes used in computer graphics as building blocks for other shapes represented as vertices and constants and store the vertices in a plurality of vertex buffers, e.g., pages of memory. When API 508 issues a render command, 3D graphics service client 510 can reformat the commands and data; package them into one or more GPU tokens; and send the GPU tokens to 3D-GPU service provider 512 along with a description of the location of the vertex buffers via shared memory 514. 3D-GPU service provider 512 can execute and extract the render command and data from the GPU tokens and translate them back into commands and data that would be issued by an API. 3D-GPU service provider 512 can then issue the commands to 3D GPU driver 516.

Graphics processing unit 504 can execute and generate a bitmap, e.g., an array of pixel values, indicative of an image frame. 3D-GPU service provider 512 can capture the bitmap and pass the bitmap to motion compensation module 404, which is described in more detail in the following paragraphs. Generally, motion compensation module 404 can compress the frame and send the image to virtual machine 414 via shared memory 514. The compressed frame can be sent to remote presentation engine 406 and sent to a client via one or more packets of information.

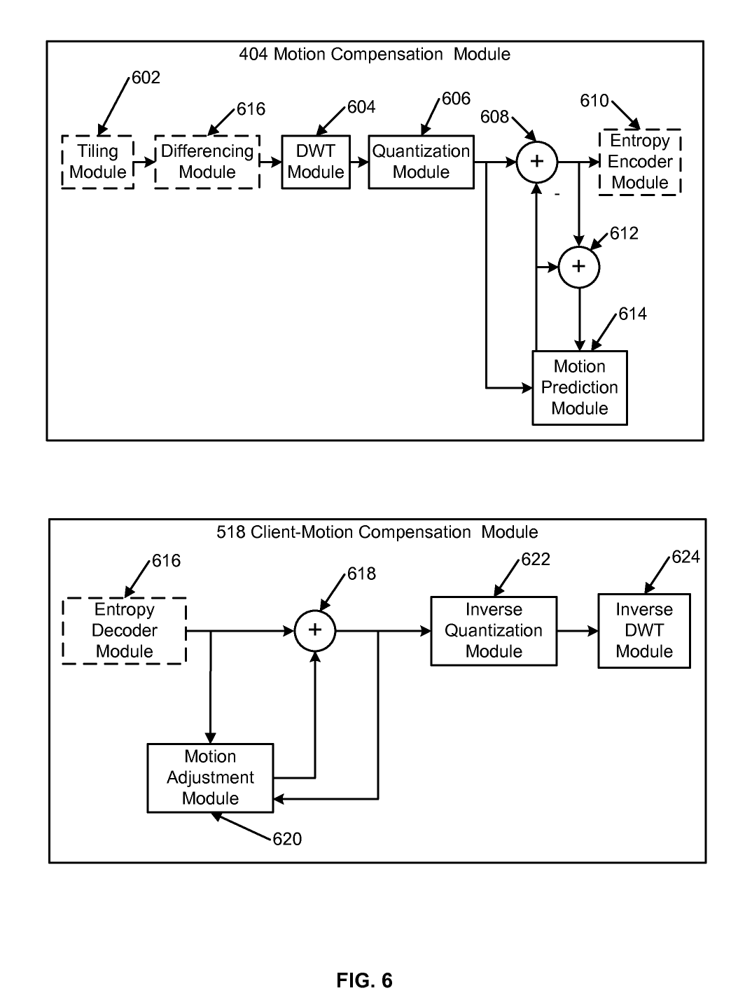

Turning now to FIG. 6, it shows exemplary modules that can be used to effect motion compensation module 404 and exemplary modules that can be used to effect client-motion compensation module 518. Some or all of the exemplary modules can be implemented in GPU executable instructions, CPU executable instructions, and/or within hardware logic. Also, some of the modules are illustrated in dashed lines to indicate that they are considered optional.

After graphical processing unit 504 generates a bitmap indicative of a frame (a source image), the frame can be captured by motion compensation module 404 and processed by tiling module 602. In an exemplary embodiment, tiling module 602 can divide the source frame into individual tiles that are implemented as contiguous sections of image data from the source image. In a specific embodiment, a 1024×1024 frame of pixels can be divided into 16 tiles of 64×64 pixels.

Continuing with the description of FIG. 6, after the frame is split into tiles, each tile can optionally be processed by differencing module 616. Differencing module 616 can receive the tiles and compare the current tiles to corresponding reference tiles. The reference tiles can be the corresponding tile from a previous frame (a reference tile). In this example, differencing module 616 can determine whether the current tiles have been altered with respect to the comparison tiles by comparing the bitmap indicative of the tile to a pervious version of the same tile. If the pixel values in a tile have not changes from one frame to the next, then differencing module 616 discards the tile. In an exemplary embodiment where differencing module 616 is effected by executable instructions that are run on processor 102, SIMD instructions, multiple tiles can be simultaneously compared to reference tiles in a single operation. In another exemplary embodiment, differencing module 616 can be effected by shader instructions running on 3D graphics processing unit 504. In this example, the multiple shader pipelines of 3D graphics processing unit 504 can be used to simultaneously compare source tiles to reference tiles.

After the changed tiles are detected, motion compensation module 404 can be configured to estimate how the tiles changed from previous versions and send the difference (the delta) to client 520. In essence, motion compensation involves searching for one or more motion vectors; applying the one or more motion vectors to a source image; and calculating the delta between a source image repositioned in accordance with the one or more motion vectors. Motion vector accuracy depends on the number of motion vectors used in an image and the accuracy of the search.

In an exemplary embodiment the motion vector search operation and the delta calculation can be performed after a discrete wavelet transform has been performed on the source image tile by DWT module 604. Searching for a motion vector and generating delta arrays, e.g., the array of pixel values that represent the difference between the reference image tile and the repositioned source image tile, on data in the DWT domain reduces the strain on virtual desktop server 400 by eliminating overhead experienced by traditional compression techniques due to the fact that they perform motion vector searches and delta array calculations in the spatial domain. That is, an inverse DWT operation, which is typically performed, does not need to be executed on virtual desktop server 400 because searching and delta array calculation occur in the DWT domain. Similar to frame differencing module 616, DWT module 604 can be effected by executable instructions that are run on processor 102 and SIMD instructions can be used to simultaneously perform DWT operations on a plurality of tiles in a single operation. In another exemplary embodiment, DWT module 604 can be effected by shader instructions running on 3D graphics processing unit 504. In this example, the multiple shader pipelines of 3D graphics processing unit 504 can be used to simultaneously perform DWT operations on a plurality of tiles. Finally, DWT module 604 can also be implemented in hardware logic of codec 502.

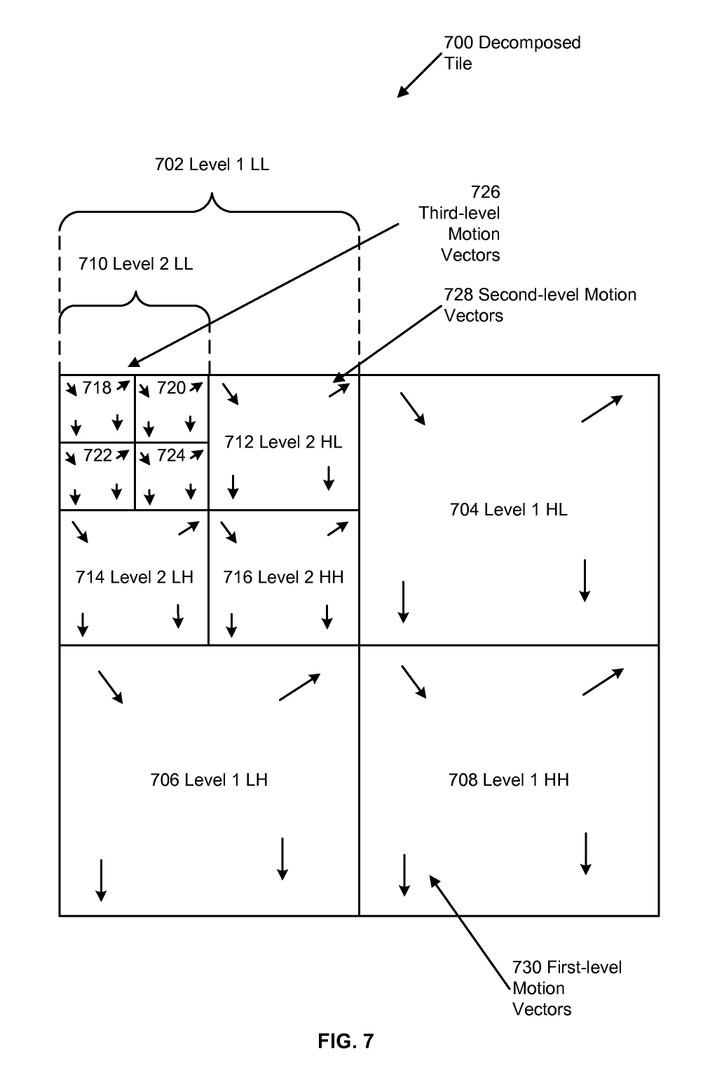

For example, and referring briefly to FIG. 7, it illustrates the resulting decomposed tile 700 obtained from three discrete wavelet transforms on an image tile. A discrete wavelet transform (DWT) decomposes the individual color components of a source image tile's pixel array into corresponding color sub-bands. For example, after a single transform, the image tile is decomposed into four sub-bands of pixels, one corresponding to first-level low pass sub-band (LL) 702, and three other first-level sub-bands corresponding to horizontal (HL) 704, vertical (LH) 706, and diagonal high pass (HH) 708 sub-bands. Generally, the decomposed image shows a coarse approximation image in the LL sub-band, and three detail images in higher sub-bands. Each first-level sub-band is a fourth of the size of the original tile (i.e., 32×32 pixels in the instance that the original tile was 64×64 pixels). As shown by the figure, first-level low pass band 702 can further be decomposed to obtain another level of decomposition thereby producing 16×16 pixel second-level sub-bands 710, 712, 714, and 716. Level-two LL sub-band 710 can be further decomposed into four 8×8 pixel third-level sub-bands: third-level LL 718, third-level LH 722, third-level HL 720, and third-level HH 724.

Turning briefly back to FIG. 6, after the discrete wavelet transformed tiles are obtained, the tiles can be sent to quantization module 606, which can be configured to compress the sub-band images, and then to motion prediction module 614. Motion prediction module 614 can be configured to search for motion vectors in one or all of the LL sub-bands, e.g., first-level LL sub-band 702, second-level LL sub-band 710, or third level LL sub-band 722 of FIG. 7. The selection of which LL sub-band to search depends on the goals of the implementer. For example, a motion vector search can be performed faster in the third-level than in the second-level; however, since the third-level has a lower resolution, the motion vector is less accurate. If an implementer wants to optimize for speed, he or she can perform the search in the third-level. If an implementer wants to optimize for accuracy, he or she can perform the search in the first-level. In another embodiment, an implementer can use the motion vector obtained from a higher level (the third-level) as a reference point for a search in a lower level (the second-level).

Turning back to FIG. 7, it illustrates a search in third-level LL sub-band 718. As shown by the figure, four motion vectors were obtained in third-level LL sub-band 718 (while four motion vectors were obtained, one of skill in the art can appreciate that a fewer or greater number of motion vectors can be obtained). For example, motion prediction module 614 can be configured to sub-divide third-level LL sub-band 718 into four blocks of 4×4 pixels and then conduct a search thereby producing 4 motion vectors in third-level LL sub-band 718.

The search can be conducted by comparing the 4×4 blocks of pixels to other pixels in third-level LL sub-band 718. For example, a first block of pixels from the source image can be compared to a corresponding block of pixels from the reference image and the error, i.e., the difference between the two blocks, can be calculated. Motion compensation module 404 can move the first block of pixels from the source image; record the vector used to reposition the block; and compare the repositioned first block of pixels to the new corresponding block of pixels from the reference image. This operation can occur until a predetermined number of comparison operations occur, or a minimum error value is obtained. In the instant that the minimum error value is not obtained, the vector used to produce the lowest error can be selected as a motion vector for the first block of pixels. Motion compensation module 404 can simultaneously calculate the motion vectors for the second, third, and fourth blocks of pixels on processor 102, 3D graphics processing unit 504 and/or in codec 502. This group of determined motion vectors is illustrated by motion vectors 726 of FIG. 7. Since the third-level sub-bands are ¼^{th} the size of the second-level sub-bands and ⅛^{th} the size of the first-level sub-bands, each third-level motion vector can be multiplied by a scalar in order to obtain second-level motion vectors 728 and multiplied by another scalar to obtain first-level motion vectors 730.

In an exemplary embodiment, the error can be calculated using one of a plurality of techniques. For example, mean squared error, sum of absolute difference, mean absolute difference, sum of squared errors, and sum of absolute differences metrics can be used to calculate error. In an exemplary embodiment, sum of absolute differences metrics can be used because these operations can be carried out faster than some of the other metrics. For example, each pixel within a block can be represented by an integer. That is, in a 4×4 block of pixels, the block can have 16 integers, one integer per pixel. The block from the source image tile can be compared to a block of 16 pixels from the reference image tile and the absolute difference for each pixel can be obtained. The absolute differences can then be added together to obtain a sum of absolute differences value (“SAD”) value. The block from the source image tile can then be compared to other blocks from the reference image tile and SAD values can be calculated. The block with the lowest SAD value is the most similar to the reference block and the vector used to move the block of pixel values from the source image tile can be set as the motion vector.

After the motion vectors are obtained and scaled, the motion vectors can be used to generate delta arrays for each sub-band image. For example, each sub-band image, e.g., 10 sub-band images in the instance that the motion vector search is performed in third-level LL sub-band 718, can be sent to summation module 608, which can use the motion vectors to shift the sub-band images and subtract the source image tiles from the reference image tiles to create delta arrays. In the embodiment illustrated by FIG. 7, 10 delta arrays can be generated in the DWT domain: one for each sub-band images.

As shown by FIG. 6, the delta arrays can be sent to an entropy encoder module 610, which can perform an entropy encoding procedure to compress the delta arrays and motion vectors. Entropy encoder module 610 can be configured to select one of a plurality of different encoders to perform an entropy encoding procedure based on the available transmission bandwidth and memory resources. Exemplary entropy encoding techniques can include those described in U.S. Pat. No. 7,460,725 entitled “System and method for effectively encoding and decoding electronic information,” the content of which is herein incorporated by reference in its entirety. The compressed delta arrays and motion vectors can then be sent to client 520 along with delta arrays and motion vectors for every other tile in the frame in one or more tile packages. In addition, the delta arrays and motion vectors can be sent to another adder module 612, which can add the delta arrays to sub-band reference tile images repositioned by the motion. These sub-band reference tile images reflect the state of client 520 and can be used as reference tile images during the next capture operation instead of using reference images from the spatial domain.

Turning back to FIG. 5, client 520 can receive one or more packets indicative of the motion vectors and delta arrays via the Internet and route the information contained within the packets to client 3D graphics processing unit 524, a codec (not showed), or client processor 526. Client-motion compensation module 518 can decompress the tiles; reconstruct the frame; and write a bitmap indicative of the frame to memory. The bitmap can then be displayed by user interface 522.

Referring to FIG. 6, client-motion compression module 518 can receive tile packages and extract the sub-band images and motion vectors for a tile and send the sub-band images and motion vectors for the tile to entropy decoder module 616, which can decompress sub-band images and motion vectors. As shown by the figure, the motion vectors can be sent to motion adjustment module 620, which can include sub-band images indicative of the tile currently being displayed by user interface 522. The motion vectors can be used to reposition the sub-band images indicative of the tile currently being displayed by user interface 522 and the repositioned sub-band images can be sent to adder module 618, which can add the delta arrays to the repositioned sub-band images. In a specific example, the four sections of a first-level HH sub-band image associated with the currently displayed frame can be repositioned in accordance with four first-level scaled motion vectors 730 and sent to adder module 618. The array of pixels that represents the first-level HH sub-band image associated with the currently displayed frame can be added to a delta array for the first-level HH sub-band image. Similar operations can be performed for each sub-band image in parallel.

The resulting motion compensated sub-band images can be sent to an inverse quantization module 622 and then to inverse discrete wavelet transform module 624. Inverse discrete wavelet transform module 624 can be configured to compose a tile from the motion compensated sub-band images. Referring to FIG. 7, in an exemplary embodiment inverse DWT module 624 of FIG. 6 can be configured to compose an image tile from the 10 sub-band images illustrated in FIG. 7. In this example, inverse DWT module 624 can compose the third-level sub band images (718, 720, 722, and 724) into second-level LL sub-band image 710. Inverse DWT module 624 can then take second-level LL sub-band image 710, second-level LH sub-band image 714, second-level HL sub-band image 712, and second-level HH sub-band image 716 and compose them to form first-level LL sub-band image 702. Finally, inverse DWT module 624 can take first-level LL sub-band image 702, first-level LH sub-band image 706, first-level HL sub-band image 704, and first-level HH sub-band image 708 and compose them into an image tile. Inverse DWT module 624 could be running in parallel on graphics processing unit 504 or processor 102 and could compose the other tiles with a single operation. The tiles can then be arranged and written to memory. The bitmap indicative of the frame can then be rendered to user interface 522.

The following are a series of flowcharts depicting operational procedures. For ease of understanding, the flowcharts are organized such that the initial flowcharts present implementations via an overall “big picture” viewpoint and subsequent flowcharts provide further additions and/or details that are illustrated in dashed lines. Furthermore, one of skill in the art can appreciate that the operational procedure depicted by dashed lines are considered optional.

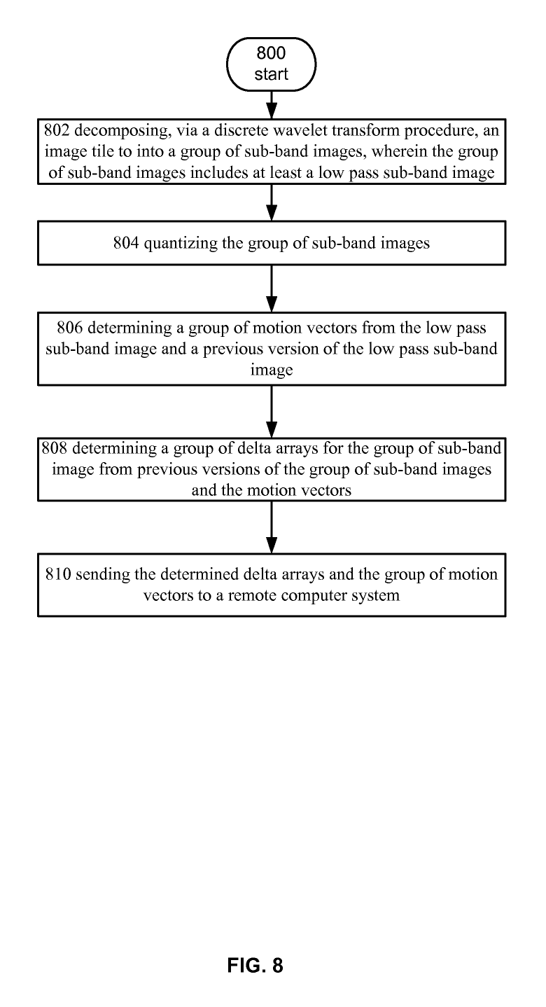

Referring to FIG. 8, it illustrates an operational procedure for compressing images during a virtual desktop session including the operations 800-810. Operation 800 begins the operational procedure and operation 802 shows decomposing, via a discrete wavelet transform procedure, an image tile to into a group of sub-band images, wherein the group of sub-band images includes at least a low pass sub-band image. For example, in an embodiment a discrete wavelet transform module 604 can be configured to decompose, i.e., separate, an image tile, i.e., a sub-section of an image, into sub-bands. For example, and referring to FIG. 7, the sub-bands can include at least a level low pass sub-band (LL) such as LL sub-band 718, 710, or 702. The low level pass sub-band shows a coarse approximation of the image tile in the lowest resolution as compared to the other sub-bands.

Continuing with the description of FIG. 8, operation 804 shows quantizing the group of sub-band images. For example, in an embodiment after decomposition, but before motion estimation, the group of sub-band images can be quantizied by quantization module 606. In this exemplary embodiment, quantization can be used to compress the sub-band images.

Operation 806 shows determining a group of motion vectors from the low pass sub-band image and a previous version of the low pass sub-band image. For example, and turning again to FIG. 6, in this example motion compensation module 404 can include motion prediction module 614, e.g., executable instructions. In this example, motion prediction module 614 can determine motion vectors, e.g., two-dimensional vectors, that can define offsets from the coordinates of pixels in a source image tile by searching the low pass sub-band image of the tile.

In at least one exemplary embodiment, a 9-point diamond search can be conducted to find suitable motion vectors. For example, a center point in the pixel array of the reference sub-band tile image can be selected along with blocks of pixels from the source low level pass sub-band tile image. SAD values can be calculated for each point on the diamond by comparing the blocks of pixels for the source low level pass sub-band tile image to the reference sub-band tile image, and the lowest SAD value can be saved. The center point of the diamond can then be shifted to, for example, the point with the lowest SAD value and SAD values can be calculated for 5 points of the diamond. The lowest SAD value from this operation can be saved. In an exemplary embodiment, the coordinates for the point with the lowest SAD value can be set as a motion vector or a desired number of additional iterations can be performed. The longer the search, the longer the compression scheme takes.

Continuing with the description of FIG. 8, operation 808 shows determining a group of delta arrays for the group of sub-band image from previous versions of the group of sub-band images and the group of motion vectors. For example, and referring again to FIG. 6, the group of motion vectors can be used to determine a delta arrays for each sub-band image in the group. For example, the motion vectors can be used to shift the sub-band images relative to reference sub-band images and then the differences can be calculated. For example, a first level diagonal sub-band image (HH) from the current tile, i.e., the source, and a reference first level diagonal sub-band image that was previously obtained, e.g., during a previous capture operation, can be sent to adder module 608. The center points of each block of pixels within the first level diagonal sub-band image can be repositioned using motion vectors. After the source sub-band image is repositioned, the array of pixels that represents the reference sub-band image can be subtracted from the source sub-band image. If the motion vector caused a good match, the resulting array should include mostly 0 values.

Turning to operation 810, it shows sending the determined delta arrays and the group of motion vectors to a remote computer system. Referring to FIG. 5, the determined delta arrays and the motion vector can be sent by motion compensation module 404 to remote presentation engine 406 via shared memory 514. Remote presentation engine 406 can execute on a virtual processor (that is, remote presentation engine 406 can run on processor 102 in a limited context) and cause the determined delta arrays and the motion vector to be sent via one or more packets to a client.

In an exemplary embodiment 3D graphics processing unit 504 can be used to effect certain of the above-mentioned operations. In this embodiment, certain functions of motion compensation module 404 can be run in parallel on 3D graphics processing unit 504. For example, in an embodiment DWT module 604, adder modules 608 and 612, and/or motion prediction module 614 can be implemented in, for example, shader instructions. Briefly, shader instructions are a set of GPU instructions which are primarily used to calculate rendering effects. Since shaders are written to apply transformations to a large set of elements the shaders are well suited to handle parallel processing for motion compensation module 404 so that multiple tiles can be processed simultaneously.

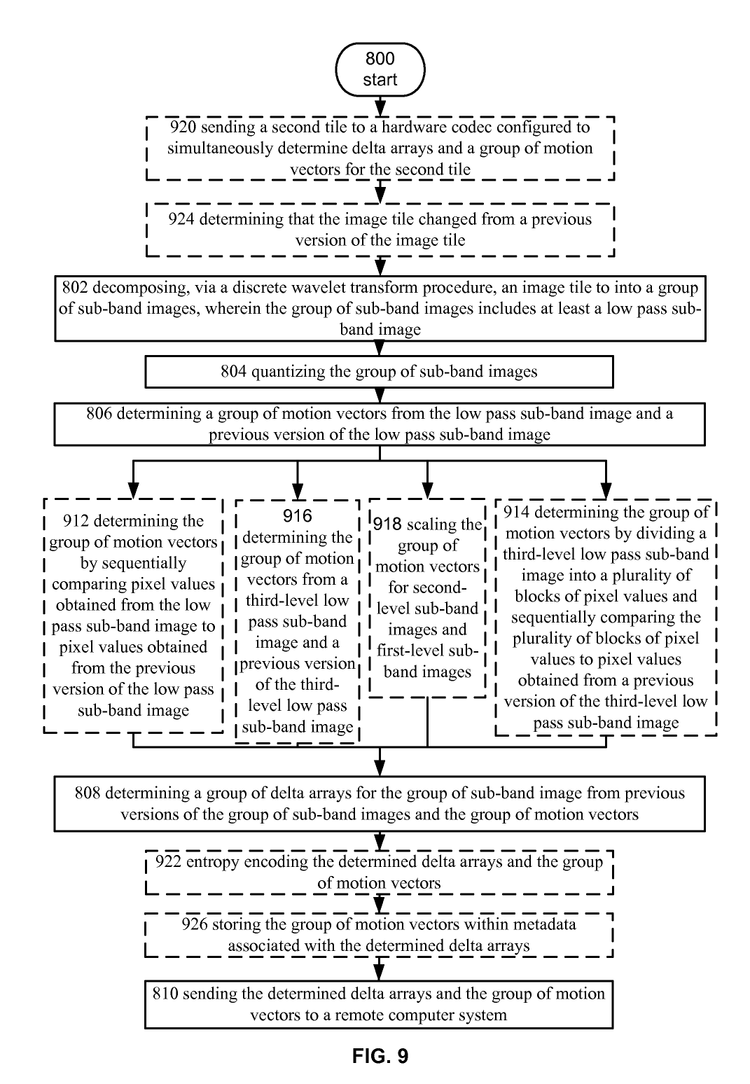

Referring now to FIG. 9, it illustrates an alternative embodiment of the operational procedure of FIG. 8 including the additional operations 912-926. Operation 912 illustrates determining the group of motion vectors by sequentially comparing pixel values obtained from the low pass sub-band image to pixel values obtained from the previous version of the low pass sub-band image. For example, motion prediction module 614 can be configured sequentially compare a block of pixel values from the source low pass sub-band image to blocks of pixel values from the reference image. For example, motion prediction module 614 can select a block of pixel values and record the coordinates of the source block. Motion prediction module 614 can then compare the source block to a reference block having the same coordinates and determine if the block matches. Motion prediction module 614 can then reposition the source block; record the vector it used to reposition the source block; and compare the source block to the pixel values from the reference block at that position and calculate the error between the two. Motion prediction module 614 can continue this process until a calculation under a predefined error threshold is made or a predetermined number of comparison operations occur. While this process is occurring, motion prediction module 614 could be performing the same operation with a plurality of different blocks of source pixels. After this process ends, motion prediction module 614 can be configured to select vector used to obtain the lowest error as a motion vector.

Continuing with the description of FIG. 9, operation 914 illustrates determining the group of motion vectors by dividing a third-level low pass sub-band image into a plurality of blocks of pixel values and sequentially comparing the plurality of blocks of pixel values to pixel values obtained from a previous version of the third-level low pass sub-band image. For example, and referring to FIG. 6, in an embodiment motion prediction module 614 can be configured to determine four motion vectors: one motion vector per 4×4 block of pixels from third-level low pass sub-band image 718. This sub-band image tile can be obtained by decomposing the first-level low pass sub-band 702 and then decomposing the second-level low pass sub-band 710. This set of operations produces third level LL 718. The group of four motion vectors can then be determined using techniques similar to those described above.

Continuing with the description of FIG. 9, operation 916 illustrates determining the group of motion vectors from a third-level low pass sub-band image and a previous version of the third-level low pass sub-band image. For example, and referring to FIG. 6, in an embodiment motion prediction module 614 can be configured to determine a motion vector from the third level low pass sub-band (Level 3 LL 718). This sub-band image tile can be obtained by decomposing the first-level low pass sub-band 702 and then decomposing the second-level low pass sub-band 710. This set of operations produces third level LL 718. Since the resolution is so low, the resulting motion vector is less precise than one that would be obtained by searching within a numerically lower sub-band, however the search can be completed faster because the number of pixels that form the image is small and the low resolution makes finding a match easier.

Turning now to operation 918, it shows scaling the group of motion vectors for second-level sub-band images and first-level sub-band images. Referring again to FIG. 6, in an exemplary embodiment the motion vector can be obtained from a higher sub-band, i.e., the second-level, and scaled so that it can be applied to numerically lower level sub-band images, i.e., first-level sub-band images. For example, in an embodiment where the motion vectors are obtained from third-level low pass sub-band 718, they can be multiplied by a scaling value so that they can be applied in the second-level sub-bands (712, 714, and 716) and multiplied by another scaling value so that they can be applied in the first-level sub-band (704, 706, and 708). In an exemplary embodiment, third-level low pass sub-band 718 is ⅛^{th} the size of the original image and the motion vectors obtained from this sub-band can be multiplied by 2 in order to obtain motion vectors for the second-level sub-bands and by 4 in order to obtain the motion vectors for the first-level sub-band. In this example, after the scaled motion vectors are obtained, these vectors along with a source group of source sub-band images and reference sub-band images can be sent to adder module 608 in order to determine a plurality of delta arrays.

Operation 920 shows sending a second tile to a hardware codec configured to simultaneously determine delta arrays and a group of motion vectors for the second tile. For example, and referring to FIG. 5, in an exemplary embodiment a second tile can be sent to codec 502 and delta arrays and motion vectors for the second tile can be simultaneously determined for the second tile while the delta arrays and motion vectors for the first tile are being determined.

Turning to operation 922, it shows entropy encoding the determined delta arrays and the group of motion vectors. For example, and referring to FIG. 6, entropy encoding module 610 can be configured to entropy encode the delta arrays for the group of sub-band images and the motion vector prior to sending them to remote presentation engine 406. In this example embodiment, entropy encoding module 610 can use a lossless data compression algorithm to compress the delta arrays and the motion vector.

Since certain encoding schemes require more resources, i.e., memory and CPU cycles, to effect, in an exemplary embodiment, entropy encoding module 610 can be configured to select an encoder from a group of encoders based on the current memory bandwidth. For example, in an embodiment an entropy encoding module 610 can include a Context-Based Adaptive Binary Arithmetic Coding encoder (CABAC) module or a Run-Length Encoding encoder (RLE) module. In an instance that entropy encoding module 610 is used along with quantization module 606, entropy encoding module 610 can be configured to adjust one or more quantization parameters to adjust the quality of the images and/or based on available memory bandwidth.

Turning to operation 924, it shows determining that the image tile changed from a previous version of the image tile. For example, in an embodiment motion compensation module 404 can be configured to apply motion estimation techniques to tiles that have changed since the last capture. For example, graphics processing unit 504 can execute and draw a bitmap to memory that includes tiles that have not changed since the last render operation. In this example, the array of pixels indicative of the image can be broken up into tiles, e.g., smaller arrays, by tiling module 602 and send to differencing module 616. Differencing module 616 can be configured to compare each tile to a reference tile, e.g., the previous version of the tile. In the instant that the pixel values for a tile are the same as the previous version of the tile, differencing module 616 can discard the tile. In the instant that there is a difference, differencing module 616 can forward the tile to discrete wavelet transform module 604.

Referring now to operation 926, it shows storing the group of motion vectors within metadata associated with the determined delta arrays. Turning again to FIG. 5, in an exemplary embodiment, the delta arrays can be packaged together in a tile package and the tile package can be packaged with tile packages for every tile in the frame into a frame package. The frame package can then be sent to remote presentation engine 406, which can insert the frame package into one or more packets of information and send the packets to client. In this example, each tile package can include a header that can store metadata. In this exemplary embodiment, the motion vector for the delta arrays can be inserted into the header along with a bit that indicates that the tile has been motion compensated.

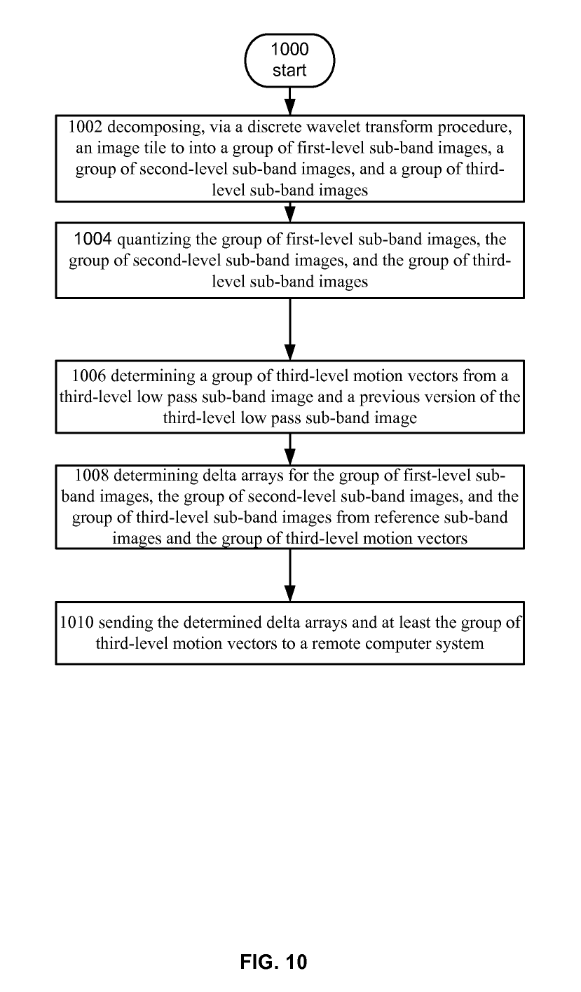

Turning now to FIG. 10 it illustrates an operational procedure for compressing an image including the operations 1000-1010. Operation 1000 begins the operational procedure, and operation 1002 shows decomposing, via a discrete wavelet transform procedure, an image tile to into a group of first-level sub-band images, a group of second-level sub-band images, and a group of third-level sub-band images. For example, in an embodiment a discrete wavelet transform module 604 can be configured to decompose, i.e., separate, an image tile, i.e., a sub-section of the pixel values indicative of an image, into sub-bands by performing discrete wavelet transforms on the tile image. In an exemplary embodiment, DWT module 604 can be implemented by a processing unit executing instructions, or within a hardware codec 502 attached to the motherboard of virtual desktop server 400, etc. In the hardware codec example, 3D-GPU service provider 512 can capture the image and send it to codec 502 for processing by codec circuitry.

For example, and referring to FIG. 7, DWT module 604 can be configured to perform three levels of discrete wavelet transforms. The first DWT operation can separate the image tile into first level horizontal sub-band (HL) 704, first level vertical sub-band (LH) 706, a first level diagonal sub-band (HH) 708, and a first level low pass sub-band (LL) 702 components. After the first DWT operation is completed, first-level low pass sub-band image 702 can be fed back into the DWT module and a group of second-level sub-band images can be produced, which can include second-level horizontal sub-band 712, second-level vertical sub-band image 714, second-level diagonal sub-band image 716, and second-level low pass sub-band image 710. Finally, a third discrete wavelet transform can be performed on second-level low pass sub-band image 710 to generate the group of third-level sub-band images, which can include third-level horizontal sub-band 712, third-level vertical sub-band image 714, third-level diagonal sub-band image 716, and third-level low pass sub-band image 718.

Referring back to FIG. 10, operation 1004 shows quantizing the group of first-level sub-band images, the group of second-level sub-band images, and the group of third-level sub-band images. For example, in an embodiment after decomposition, but before motion estimation, the group of sub-band images can be quantizied by quantization module 606. In this exemplary embodiment, quantization can be used to compress the groups of sub-band images.

Operation 1006 shows determining a group of third-level motion vectors from a third-level low pass sub-band image and a previous version of the third-level low pass sub-band image. For example, and turning again to FIG. 6, in this example motion compensation module 404 can include motion prediction module 614, e.g., executable instructions or logic integrated within codec 502. In this example, motion prediction module 614 can determine third-level motion vectors by searching third-level low pass sub-band image 718 after the group of sub-band images is quantizied.

Turning now to operation 1008, it illustrates determining delta arrays for the group of first-level sub-band images, the group of second-level sub-band images, and the group of third-level sub-band images from reference sub-band images and the group of third-level motion vectors. For example, and turning to FIG. 6, in an embodiment, a group of motion vectors, e.g., four motion vectors: one motion vector per 4×4 block of pixels of third-level low pass sub-band image 718, can be sent to adder module 608 with the group of first-level sub-band images, the group of second-level sub-band images, the group of third-level sub-band images, reference images, e.g., previous versions of the group of first-level sub-band images, the group of second-level sub-band images, and the group of third-level sub-band images. In this example, adder module 608 can be configured to shift the groups of sub-band images according to the appropriate motion vector and calculate difference arrays.

In a specific example, the third-level sub-band images (LL 718, HL 712, LH 714, and HH 724) can be shifted a number of pixels based on the third-level motion vectors and difference arrays can be determined by comparing the pixel values from the third-level sub-band images to reference third-level sub-band images. Similarly, adder module 608 can scale third-level motion vectors 726 by 2 and use them to calculate difference arrays from reference second-level sub-band images and scale third-level motion vectors 726 by 4 and use them to calculate difference arrays from reference first-level sub-band images. At the end of this process, adder module 608 can have 10 difference arrays and 40 motion vectors.

Turning now to operation 1010, it shows sending the determined delta arrays and at least the group of third-level motion vectors to a remote computer system. Referring to FIG. 5, the determined delta arrays and the determined motion vectors can be packaged into a tile package and sent by motion compensation module 404 to remote presentation engine 406 via shared memory 514. Remote presentation engine 406 can execute on a virtual processor and cause the tile package to be sent via one or more packets to a client.

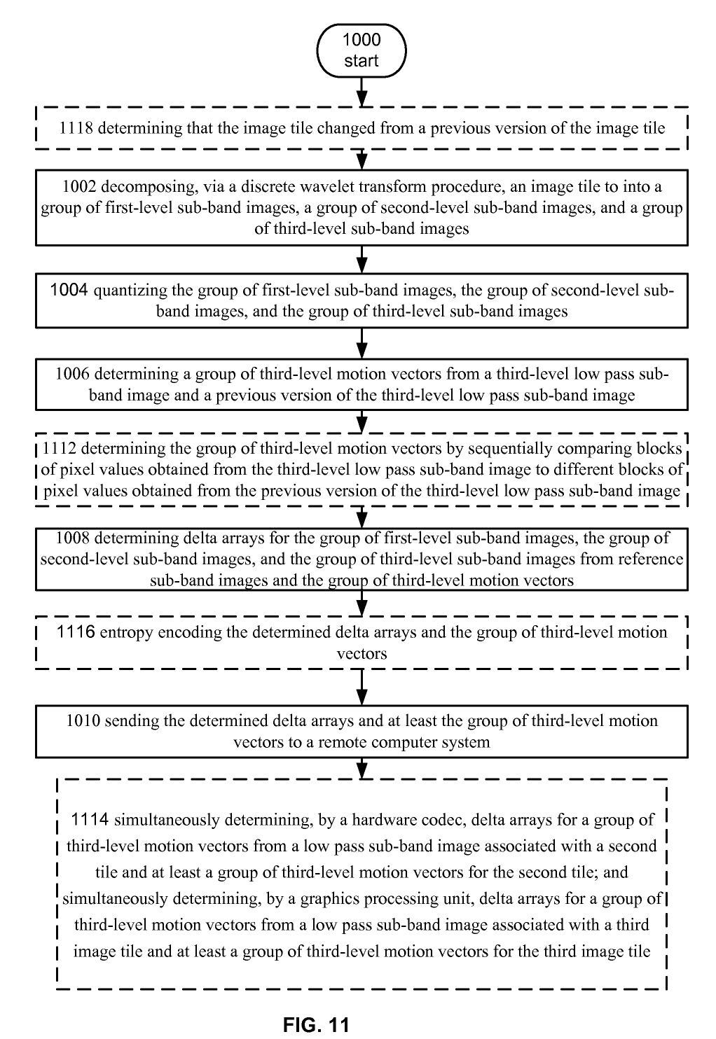

FIG. 11 illustrate an alternative embodiment of the operational procedure illustrated by FIG. 10 including the additional operations 1112-1118. Operation 1112 illustrates that in this exemplary embodiment the operational procedure can include an operation for determining the group of third-level motion vectors by sequentially comparing blocks of pixel values obtained from the third-level low pass sub-band image to different blocks of pixel values obtained from the previous version of the third-level low pass sub-band image. For example, motion prediction module 614 can be configured to use an evaluation metric to search third-level motion vector 718. In an exemplary embodiment, motion prediction module 614 can break third-level motion vector 718 into 4 quadrants and can sequentially compare blocks of pixel values from each quadrant to blocks of pixel values from the reference image. Motion prediction module 614 can continue to search until the calculation produces an error value that is less than a predefined error threshold or a predetermined number of calculations occur.

Operation 1114 shows simultaneously determining, by a hardware codec, delta arrays for a group of third-level motion vectors from a low pass sub-band image associated with a second tile and at least a group of third-level motion vectors for the second tile; and simultaneously determining, by a graphics processing unit, delta arrays for a group of third-level motion vectors from a low pass sub-band image associated with a third image tile and at least a group of third-level motion vectors for the third image tile. For example, and referring back to FIG. 5, in an exemplary embodiment operations similar to those described above with respect to FIG. 10 can be simultaneously performed by 3D GPU 504 for a second image tile and by a hardware codec 502. In this example, tiles can be simultaneously processed by different execution units and sent to client 520.

Operation 1116 shows entropy encoding the determined delta arrays and the group of third-level motion vectors. For example, and referring to FIG. 6, entropy encoding module 610 can be configured to entropy encode the delta arrays for the group of sub-band images and the motion vector prior to sending them to remote presentation engine 406. In this example embodiment, entropy encoding module 610 can use a lossless data compression algorithm to compress the delta arrays and the motion vector.

Operation 1118 shows determining that the image tile changed from a previous version of the image tile. For example, in an embodiment motion compensation module 404 can be configured to apply motion estimation techniques to tiles that have changed since the last capture. For example, 3D graphics processing unit 504 can execute and draw a bitmap to memory that includes tiles that have not changed since the last render operation. In this example, the array of pixels indicative of the image can be broken up into tiles, e.g., smaller arrays, by tiling module 602 and sent to differencing module 616. Differencing module 616 can be configured to compare each tile to a reference tile, e.g., the previous version of the tile. In the instant that the pixel values for a tile are the same as the previous version of the tile, differencing module 616 can discard the tile. In the instant that there is a difference, differencing module 616 can forward the tile to discrete wavelet transform module 604.

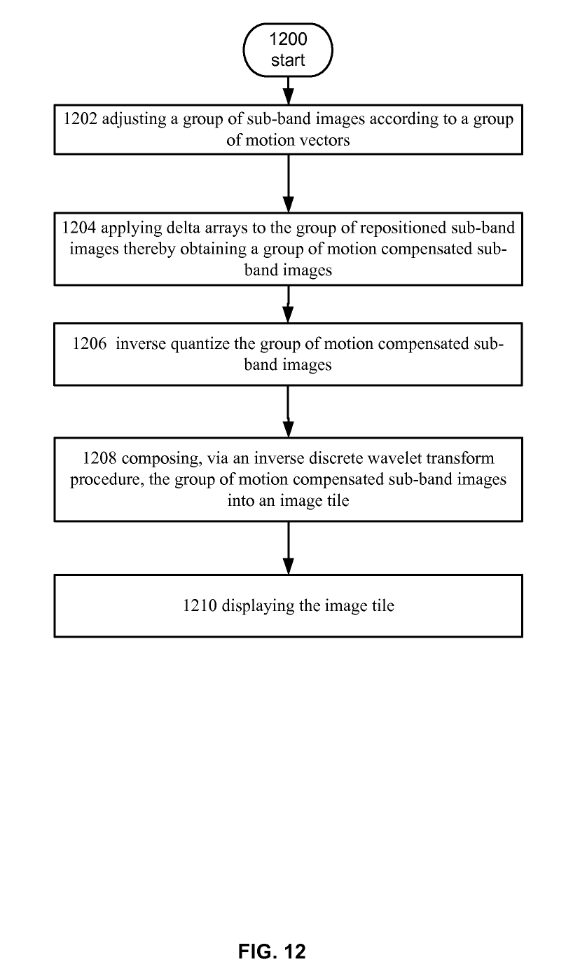

Turning now to FIG. 12, it shows an operational procedure for decompressing an image including operations 1200, 1202, 1204, 1206, 1208, and 1210. Operation 1200 begins the operational procedure and operation 1202 shows position adjusting a group of sub-band images according to a group of motion vectors. For example, and referring to FIG. 5, in an exemplary embodiment, client 520 can include client-motion compensation module 518, which can be effectuated by hardware, e.g., a codec (not shown), or by a combination of hardware/software, e.g., executable instructions that are executed by either processor 102 or 3D graphics processing unit (also not shown). In this embodiment, client 520 can be configured to receive a group of delta arrays and a group of motion vectors. In this example, client 520 can also be configured to store a copy of the discrete wavelet transformed sub-band images used to generate the frame currently being displayed, i.e., reference sub-band images. Client 520 can send the group of delta arrays and the one or more motion vectors to motion adjustment module 620 of client-motion compensation module 518. Motion adjustment module 620 can receive the group of motion vectors and use the one or more motion vectors to adjust the group of reference sub-band images. In a specific example, the group of motion vectors, can be first-level motion vectors 730 e.g., 40 motion vectors, and the discrete wavelet transformed sub-band images used to generate the current can include a first-level HH sub-band image, a first-level LH sub-band image, a first-level HL sub-band image, and a first-level LL sub-band image.

Referring now to operation 1204, it shows applying delta arrays to the group of repositioned sub-band images thereby obtaining a group of motion compensated sub-band images. For example, and referring to FIG. 6, adder module 618 can receive the position adjusted discrete wavelet transformed sub-band images used to generate the current frame and delta arrays. In this example a delta array can be added to each reference sub-band image thereby creating a group of motion compensated sub-band images.

Referring now to operation 1206, it shows inverse quantizing the group of motion compensated sub-band images. For example, and referring to FIG. 6, the group of motion compensated sub-band images can be passed to inverse quantization module 622, which can use adaptive quantization parameters to dequantize the sub-band images.

Continuing with the description of FIG. 12, operation 1208 shows composing, via an inverse discrete wavelet transform procedure, the group of motion compensated sub-band images into an image tile. For example, and turning again to FIG. 6, in an exemplary embodiment client-motion compensation module 518 can include an inverse discrete wavelet transform module 624 that can receive the motion compensated sub-band images. In this example, inverse discrete wavelet transform module 624 can assemble the motion compensated sub-band images into an image tile.

Turning now to operation 1210, it shows displaying the image tile. For example, and turning to FIG. 5, the image tile and all the other image tiles for the frame can be assembled into a frame and written to memory. Client 520 can read the bitmap and render it to a display device.

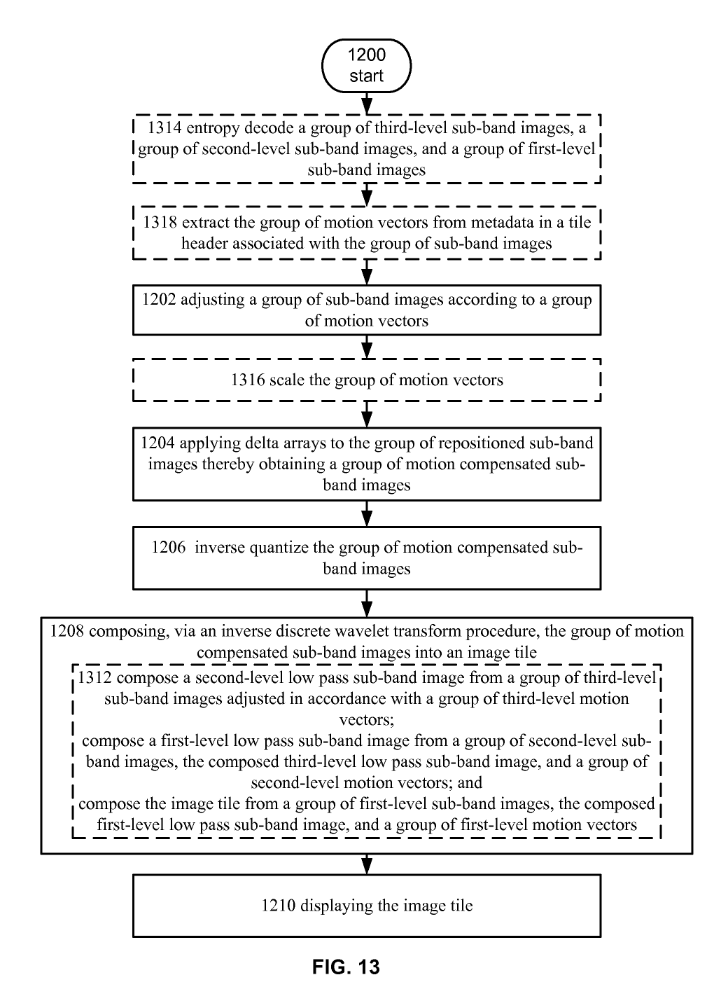

Referring to FIG. 13, it shows an alternative embodiment of the operational procedure of FIG. 12 including the operations 1312, 1314, 1316, and 1318. Operation 1312 shows composing a second-level low pass sub-band image from a group of third-level sub-band images adjusted in accordance with a group of third-level motion vectors; a first-level low pass sub-band image from a group of second-level sub-band images, the composed third-level low pass sub-band image, and a group of second-level motion vectors; and the image tile from a group of first-level sub-band images, the composed first-level low pass sub-band image, and a group of first-level motion vectors. For example, and turning to FIG. 7, in an exemplary embodiment inverse DWT module 624 of FIG. 6 can be configured to compose an image tile from the 10 sub-band images illustrated in FIG. 7. For example, motion adjustment module 620 could have previously adjusted each reference sub-band image and added it to an associated delta array. Inverse DWT module 624 can be configured in this example to compose a motion compensated second-level LL sub-band image from motion compensated third-level sub-band images. Inverse DWT module 624 can then compose a motion compensated first-level LL sub-band image from the group of motion compensated second-level sub-band images. Finally, inverse DWT module 624 can compose a motion compensated tile image from the group of motion compensated first-level sub-band images.

Turning now to operation 1314 it shows extracting the group of motion vectors from metadata in a tile header associated with the group of sub-band images. For example, in an exemplary embodiment, client-motion compensation module 518 can be configured to receive a tile package that includes, for example, a set of delta arrays, a bit indicating that the tile package is motion compensated and a group of motion vectors stored in the header. In this example, client-motion compensation module 518 can determine that the tile has been motion compensated and read the motion vectors from the tile header and pass them along with the arrays in the tile package to, for example, entropy decoder module 616 or directly to motion adjustment module 620.

Turning now to operation 1316 it shows scale the group of motion vectors. For example, in an embodiment the tile package could include 10 sub-band delta arrays, e.g., 4 third-level sub-band delta arrays, 3 second-level sub-band delta arrays, and 3 first-level sub-band delta arrays, and four motion vectors, e.g., one motion vector for each quadrant of third-level LL 718. In this example, motion adjustment module 620 can be configured to scale the group of motion vectors in order to apply them to the second-level and first-level sub-band images. In an exemplary embodiment, third-level low pass sub-band 718 is ⅛^{th} the size the original image and so the motion vectors obtained from this sub-band can be multiplied by 2 in order to obtain motion vectors for the second-level sub-bands and by 4 in order to obtain the motion vectors for the first-level sub-band.

Operation 1318 shows entropy decode a group of third-level sub-band images, a group of second-level sub-band images, and a group of first-level sub-band images. For example, and referring to FIG. 6, entropy decoder module 616 can be configured to receive 10 sub-band delta arrays and select a lossless data decompression algorithm to decompress the delta arrays. For example, the tile package can indicate what compression algorithm was used by entropy encoder module 610. In this example, entropy decoder module 616 can use this information to select the appropriate decoder and decode the sub-band delta arrays.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computer system configured to compress images during a virtual desktop session, comprising:
a processor; and
a memory in communication with the processor when the computer system is operational, the memory having stored thereon computer readable instructions that upon execution cause the processor to:
decompose, via a discrete wavelet transform procedure, an image tile to into a group of sub-band images, wherein the group of sub-band images includes at least a low pass sub-band image;
quantize the group of sub-band images;
determine a group of motion vectors from the low pass sub-band image and a previous version of the low pass sub-band image;
determine a group of delta arrays for the group of sub-band image from previous versions of the group of sub-band images and the group of motion vectors; and
send the determined delta arrays and the group of motion vectors to a remote computer system.

2. The computer system of claim 1, wherein the memory further comprises computer readable instructions that upon execution cause the processing unit to:
determine the group of motion vectors by sequentially comparing pixel values obtained from the low pass sub-band image to pixel values obtained from the previous version of the low pass sub-band image.

3. The computer system of claim 1, wherein the memory further comprises computer readable instructions that upon execution cause the processing unit to:
determine the group of motion vectors by dividing a third-level low pass sub-band image into a plurality of blocks of pixel values and sequentially comparing the plurality of blocks of pixel values to pixel values obtained from a previous version of the third-level low pass sub-band image.

4. The computer system of claim 1, wherein the memory further comprises computer readable instructions that upon execution cause the processing unit to:
determine the group of motion vectors from a third-level low pass sub-band image and a previous version of the third-level low pass sub-band image.

5. The computer system of claim 1, wherein the memory further comprises computer readable instructions that upon execution cause the processing unit to:
scale the group of motion vectors for second-level sub-band images and first-level sub-band images.

6. The computer system of claim 1, wherein the memory further comprises computer readable instructions that upon execution cause the processing unit to:
send a second tile to a hardware codec configured to simultaneously determine delta arrays and a group of motion vectors for the second tile.

7. The computer system of claim 1, wherein the memory further comprises computer readable instructions that upon execution cause the processing unit to:
entropy encode the determined delta arrays and the group of motion vectors.

8. The computer system of claim 1, wherein the memory further comprises computer readable instructions that upon execution cause the processing unit to:
determine that the image tile changed from a previous version of the image tile.

9. The computer system of claim 1, wherein the memory further comprises computer readable instructions that upon execution cause the processing unit to:
store the group of motion vectors within metadata associated with the determined delta arrays.

10. The computer system of claim 1, wherein the processor is a graphics processor unit.

11. A method for compressing images during a remote presentation session, comprising:
decomposing, via a discrete wavelet transform procedure, an image tile to into a group of first-level sub-band images, a group of second-level sub-band images, and a group of third-level sub-band images;
quantizing the group of first-level sub-band images, the group of second-level sub-band images, and the group of third-level sub-band images;
determining a group of third-level motion vectors from a third-level low pass sub-band image and a previous version of the third-level low pass sub-band image;
determining delta arrays for the group of first-level sub-band images, the group of second-level sub-band images, and the group of third-level sub-band images from reference sub-band images and the group of third-level motion vectors; and
sending the determined delta arrays and at least the group of third-level motion vectors to a remote computer system.

12. The method of claim 11, further comprising:
determining the group of third-level motion vectors by sequentially comparing blocks of pixel values obtained from the third-level low pass sub-band image to different blocks of pixel values obtained from the previous version of the third-level low pass sub-band image.

13. The method of claim 11, further comprising:
simultaneously determining, by a hardware codec, delta arrays for a group of third-level motion vectors from a low pass sub-band image associated with a second tile and at least a group of third-level motion vectors for the second tile; and
simultaneously determining, by a graphics processing unit, delta arrays for a group of third-level motion vectors from a low pass sub-band image associated with a third image tile and at least a group of third-level motion vectors for the third image tile.

14. The method of claim 11, further comprising:
entropy encoding the determined delta arrays and the group of third-level motion vectors.

15. The method of claim 11, further comprising:
determining that the image tile changed from a previous version of the image tile.

16. A computer-readable storage medium including instructions for decompressing images during a virtual desktop session, the computer-readable storage medium having stored thereon computer readable instructions that upon execution cause a processor to:
reposition a group of sub-band images according to a group of motion vectors;
apply delta arrays to the group of repositioned sub-band images thereby obtaining a group of motion compensated sub-band images;
inverse quantize the group of motion compensated sub-band images;
compose, via an inverse discrete wavelet transform procedure, the group of motion compensated sub-band images into an image tile; and
display the image tile.

17. The computer-readable storage medium of claim 16, wherein the computer-readable instructions that upon execution cause the processor to compose the group of motion compensated sub-band images further comprises computer-readable instructions that upon execution cause the processor to:
compose a second-level low pass sub-band image from a group of third-level sub-band images adjusted in accordance with a group of third-level motion vectors;
compose a first-level low pass sub-band image from a group of second-level sub-band images, the composed third-level low pass sub-band image, and a group of second-level motion vectors; and
compose the image tile from a group of first-level sub-band images, the composed first-level low pass sub-band image, and a group of first-level motion vectors.

18. The computer-readable storage medium of claim 16, wherein the computer-readable storage medium further comprises computer readable instructions that upon execution cause a processor to:
extract the group of motion vectors from metadata in a tile header associated with the group of sub-band images.

19. The computer-readable storage medium of claim 16, wherein the computer-readable storage medium further comprises graphics processing unit computer readable instructions that upon execution cause a processor to:
scale the group of motion vectors.

20. The computer-readable storage medium of claim 16, wherein the computer-readable storage medium further comprises computer readable instructions that upon execution cause a processor to:
entropy decode a group of third-level sub-band images, a group of second-level sub-band images, and a group of first-level sub-band images.
